(19) United States
(12) Patent Application Publication
(10) Pub. No.: US 2011/0221606 A1
(43) Pub. Date: Sep. 15, 2011

(54) SYSTEM AND METHOD FOR DETECTING A MOVING OBJECT IN AN IMAGE ZONE

(75) Inventors: Jiyoon Chung, Aurora, CO (US); Roosevelt Rogers, JR., Parker, CO (US)

(73) Assignees: LASER TECHNOLOGY , INC., Centennial, CO (US); KAMA-TECH (HK) LIMITED, Hong Kong (HK)

(21) Appl. No.: 12/722,363

(22) Filed: Mar. 11, 2010

(51) Int. Cl. G08B 21/00; H04N 7/18; G06F 3/041

(52) U.S. Cl. 340/686.1; 340/540; 348/149; 345/173; 348/E07.085

(57) ABSTRACT

A system and method for detection of a moving object in an image zone for possible use in the field of road and traffic safety related and/or gate monitoring systems includes an image sensor for imaging a field, a user interface for defining at least one detection zone within the field, a processor coupled to the user interface and the image sensor for detecting if a moving object has entered the at least one detection zone and an alarm providing a signal in response to detection of a moving object within the at least one detection zone.

### BACKGROUND OF THE INVENTION

The present invention relates, in general, to a system and method for the detection of a moving object in an image zone. More particularly, the present invention relates to a system and method for detection of a moving object in an image zone which may be adapted for use in the field of road and traffic safety related and/or gate monitoring systems.

### SUMMARY OF THE INVENTION

Disclosed herein is a system for moving object detection which comprises an image sensor for imaging a field, a user interface for defining at least one detection zone within the field, a processor coupled to the user interface and the image sensor for detecting if a moving object has entered the at least one detection zone and a system responsive to the processor for providing one of an alarm signal to the user or a gate actuation operation in response to detection of a moving object within the detection zone.

Further disclosed herein is a method for moving object detection which comprises imaging a visual field, defining at least one detection zone within the visual field, detecting if a moving object has entered the at least one detection zone and creating one of an alarm signal to the user or a gate actuation operation in response to detection of a moving object within the detection zone.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a functional block diagram of a system for the detection of a moving object in an image zone in accordance with an embodiment of the present invention;

FIGS. 2A and 2B are simplified representative implementations of the system of the preceding figure utilized in respective fixed and mobile applications for road and traffic safety purposes;

FIGS. 3A and 3B illustrate a typical highway scene in which areas of interest A and B along the roadway shoulder are designated for monitoring by the system and method of the present invention;

FIGS. 4A and 4B further illustrate a roadway construction site in which an area A has been designated as an area of interest for monitoring by the system and method of the present invention;

FIG. 5 is a high level logic flow chart for possible implementation of the system and method of the present invention; and

FIG. 6 is a further, more detailed logic flow chart for possible implementation of the system and method of the present invention.

### DESCRIPTION OF A REPRESENTATIVE EMBODIMENT

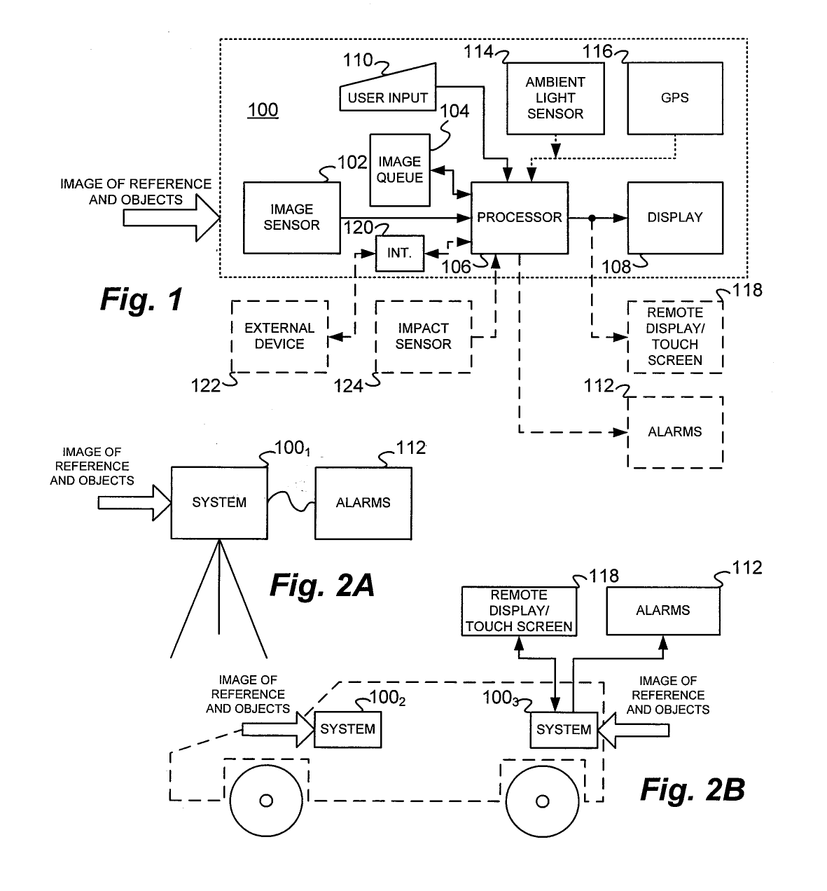

With reference now to FIG. 1, a functional block diagram of a system 100 for the detection of a moving object in an image zone in accordance with an embodiment of the present invention is shown. The system 100 comprises an image sensor 102 which receives an image of a reference scene and an object in an image zone as will be more fully described hereinafter.

A number of images received by the image sensor 102 are electronically placed in an image queue 104 by the processor for subsequent processing. The processor 106 is coupled to a display 108 for viewing by a user of the system 100. The processor 106 receives as input the output of a user input system 110 which may comprise a keypad, keyboard, pointing device, a touch screen or other known user input device. The processor 106 operates on the images stored in the image queue 104 in conjunction with the user input system 110 to produce, as appropriate, a user audible and/or visual or other user discernable alarm of the presence of an object in a determined image zone through the use of alarms 112.

The system 100 may also optionally include an ambient light sensor 114 and/or global positioning system (“GPS”) 116 providing input to the processor 106 as indicated. Further, the system 100 may also be coupled to a remote display 118 which may further include a touch screen input as an alternative to, or supplementary to, the user input 110.

In other embodiments of the present invention, the system 100 may further include an external device 122, for example, a removable storage medium, coupled to the processor 106 by an appropriate high speed module or interface 120. Other embodiments of the system 100 may include an impact sensor 124.

With reference additionally now to FIGS. 2A and 2B, simplified representative implementations of the system 100 of the preceding figure are shown in respective fixed (FIG. 2A) and mobile (FIG. 2B) applications for road and traffic safety purposes. The system 100₁ of FIG. 2A may be affixed to a tripod or other form of support at a roadside or construction site wherein the alarms 112 may comprise a loud speaker and/or flashing lights or other visual indication of an object in a defined image zone.

Alternatively, the front mounted system 100₂ of FIG. 2B may additionally comprise, for example, an internal beeper or other audible annunciator as well as an LCD display and touch screen for providing a display and user defined input. The rear mounted system 100₃ may also, for example, comprise a remote display/touch screen 118 as well as alarms 112 coupled together by a high speed communications link or bus.

In the representative embodiments of the present invention shown in the preceding figures, a road or traffic safety device is implemented in conjunction with a system 100 which is tightly coupled with, and/or comprises, an image sensor 102 and a processor 106. For example, the image sensor may be one of a number of conventional image sensors (e.g., a Micron Technology, Inc. MT9T001 which has a resolution of 2048×1536 pixels.). The processor 106 may also be one of the available high performance embedded processor devices (e.g., a Texas Instruments, Inc. OMAP 3503 which can provide approximately 1200 Dhrystone MIPS.)

The processor 106 may communicate with the image sensor 102 through, for example, a parallel bus. An image of a reference scene and various objects is communicated to the processor 106 by the image sensor 102 on a pixel-by-pixel basis in accordance with an established timing. Once a frame (e.g. one image) is collected, the processor 106 saves the image into an image queue 104 for subsequent image processing.

In an overall sense, image processing in accordance with the system and method of the present invention may comprise: a) reference image building; b) detection of moving objects; and c) classification of objects.

The reference image building process involves taking a frame from the image queue 104. However, the processor 106 does not remove this frame from the image queue 104. Rather, this given frame is effectively subtracted from the previous one in order to extract the non-changed zones, with such zones being logically accumulated into a reference image. In this context, “logical accumulation” means that each frame is divided into multiple small sub-zones. Each sub-zone has a unique identity and each unique identity maintains the probability of reference. In practice, the data structure of these sub-zones can be a two dimensional table, linked list or their variants. It should be noted that the reference may not be a solid object, in other words, the reference might be moving (e.g., trees or signs can be moved by wind or other reason). Therefore, the system 100 is operative to determine whether a detected movement is from objects or a reference (actually the movement of a reference is generally a low frequency vibration). On the other hand, in order to detect objects, the processor 106 takes a frame from the image queue 104 and removes it from the image queue 104.

Detecting moving objects may be implemented through any conventional motion flow method wherein the motion flow method attempts to find moving pixels. All pixels are examined as to whether it has neighboring pixels which move in the same direction. All proximate moving pixels with the same direction are then merged and denominated as a segment. Each segment is then examined and the size, location and direction of the segment is calculated. This calculated segment is then utilized to compare it to previous results in order to determine its history. If such a history is found, the identity from the history is utilized. If a history is not found, a new identity is assigned to the segment.

The series of segments (in terms of time elapsed) is examined to determine whether the segment is from an object or reference. In order to decide which one it might be, a trajectory checking technique may be used. If the series of segments moves in one direction, it is most likely from an object. If the series of segments moves up and down (e.g. vibrates), then it is most likely a reference.

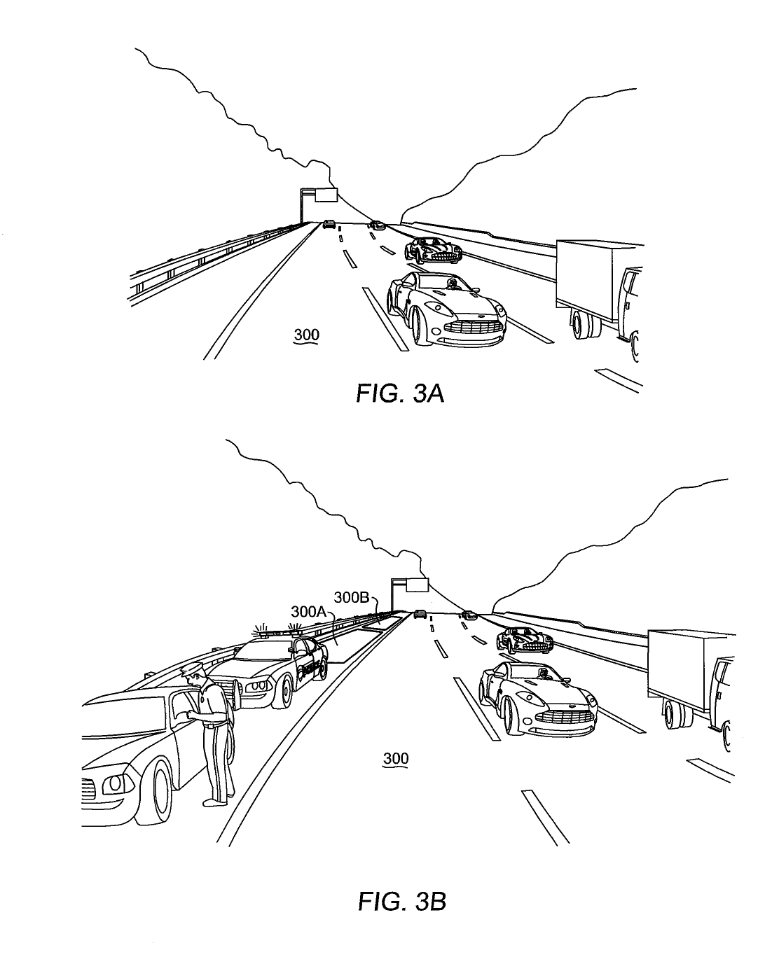

With reference additionally now to FIGS. 3A and 3B in particular, a typical highway scene 300 is illustrated in which areas of interest 300A and 300B along the roadway shoulder are designated for monitoring by the system 100 and method of the present invention. The exemplary scene 300 is one in which the system 100 may be utilized to allow a user to determine an image zone of interest (e.g. zones 300A and/or 300B along the shoulder of the roadway) and determine if a moving object enters the defined zones and provide an audio or visual warning through use of the alarms 112. As illustrated, the zones 300A and/or 300B can be set to provide, for example, an auditory warning to a police officer (through the use of a mobile or stationary implementation of the system 100 of the present invention) whose attention is otherwise not directed toward the possible approach of another vehicle behind his patrol vehicle.

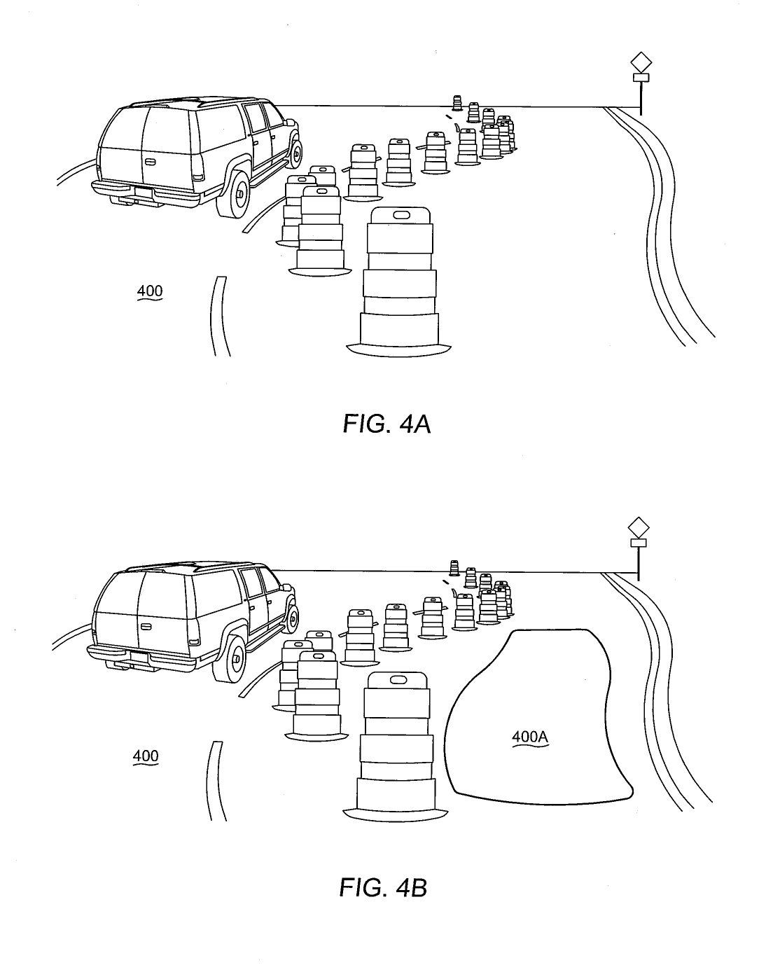

With reference additionally now to FIGS. 4A and 4B, a roadway construction site 400 is further illustrated in which an area 400A has been designated as an area of interest for monitoring by the system 100 and method of the present invention. The exemplary scene 400 includes a zone of interest 400A as to which the system 100 will similarly provide an audio or visual warning of an object moving in zone 400A through use of the alarms 112. The system 100 may similarly be used to monitor traffic gates or similar sites.

In operation, the system 100 may sometimes encounter flashing lights, particularly in construction zones. In this instance, the illumination will be changing dynamically so the system 100 may incorporate feature mapping and matching to mitigate this problem. Further, small objects such as birds or blowing leaves can lead to false object detections and the system 100 and method of the present invention accommodates such situations by utilizing both reference (e.g. background) and motion flow techniques, with the references extending to the topological relations of features which are built up and modified during monitoring. Through the use of an optional ambient light sensor 114, the system 100 can be set with parameters optimized for either daytime or nighttime operation.

In a representative implementation of the system 100 and method of the present invention, the user selects one or more specific zones for monitoring and warning as per the examples of the preceding figures. Further, the user is able to independently determine a level of warning to be provided per zone. Moreover, the user is able to also indicate some of the features of each selected zone such as the minimum size of objects to be monitored so as to obviate false alarms caused by birds, other animals or blowing debris. The direction of the moving objects can also be programmed to also obviate any false alarm signals caused by normal operations such as the departure of an authorized vehicle from a construction zone.

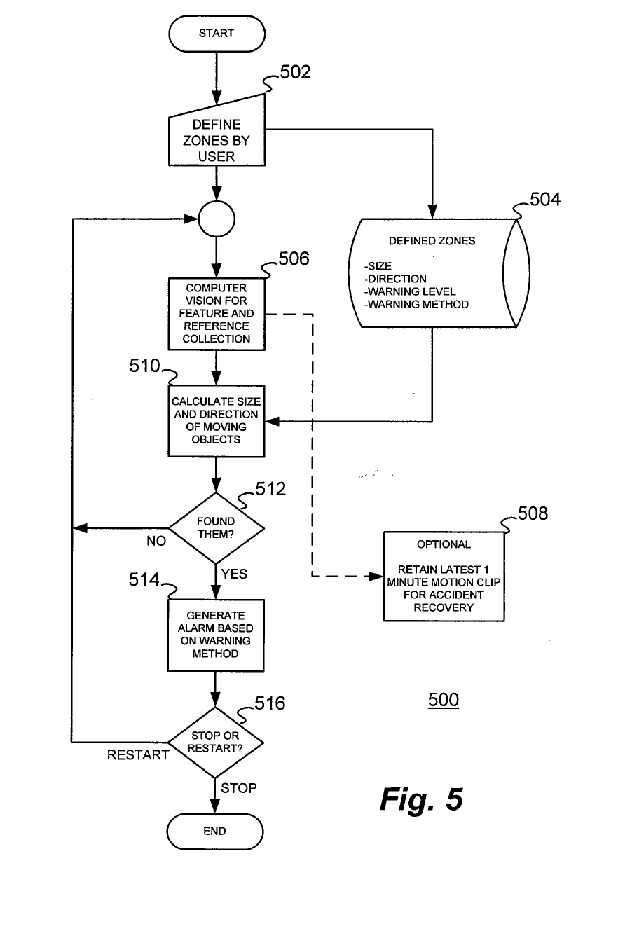

With reference additionally now to FIG. 5, a high level logic flow chart for possible implementation of the system 100 and method of the present invention is shown. The process 500 begins with the user definition of one or more particular zones of interest at input step 502. Information as to the user defined zones is stored as shown in step 504 as to, for example, object size, direction of movement, the warning level to be provided and the warning method.

The process 500 further includes the utilization of computer vision (through the image sensor 102) for feature and reference image collection at step 506. Optionally, a portion of the image data may be maintained for a determined period for subsequent accident reconstruction as shown in step 508. At step 510, the size and direction of moving objects is calculated and, if such objects are not found at decision step 512, the process 500 returns to implement step 506.

Should objects be found, then an appropriate alarm is generated at step 514 based upon the previous user defined information. At decision step 516, a determination is made as to whether or not to stop or restart the process 500 as indicated.

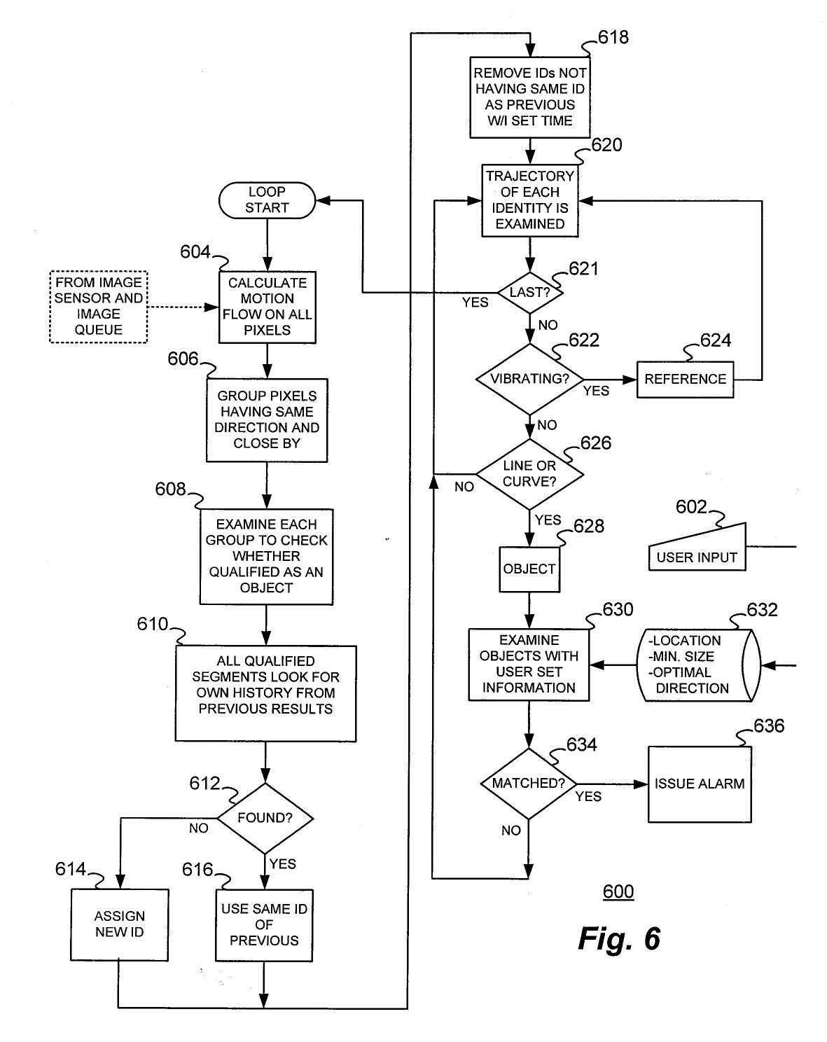

With reference additionally now to FIG. 6, a further, more detailed logic flow chart for possible implementation of the system 100 and method of the present invention is shown. The process 600 begins with user input step 602 for entry, for example, of various user defined zones, object sizes, direction and the like as previously indicated. At step 604, the system 100 calculates the motion flow on all pixels provided by the image sensor 102 and image queue 104. At step 606, the processor 106 groups the pixels according to those having the same direction and being proximate to one another, while at step 608, each such group is then examined to check as to whether they qualify as an object. In other words, the size, direction etc. should be in conformance with the parameters that the user has previously set, and if there is common data, it is qualified.

At step 610, all segments qualified in the preceding step are compared to previous results for a determination of their history. At decision step 612, if no relevant history is found, a new ID is assigned to the segment at step 614. Alternatively, if a relevant history is found, the same ID as the previously assigned one is used at step 616. IDs not having the same ID as the previous within a set time period are removed at step 618 and the trajectory of each identity is examined at step 620, wherein the trajectory is determined by a series of segments in accordance with an elapsed time.

At decision step 621, if there are no more IDs, (i.e. the system 100 encounters the last item and has failed to find moving objects) the process 600 returns to the loop start. On the other hand, if there are still more IDs, the process 600 proceeds to decision step 622. If the segment is determined to be vibrating at decision step 622, a determination is made that it relates to a reference at step 624 and the process 600 returns to step 620. Alternatively, if the segment is not vibrating, then at decision step 626 it is analyzed to see if the trajectory is that of a line or a curve. If it isn't, then the process 600 also returns to step 620, but if it is, then a determination is made that the segment relates to an object at step 628. At step 620, the trajectory is checked with the user defined direction, and if it is similar, it is an object. If direction is not defined by the user, the trajectory should optimally have one direction and must not vibrate.

At step 630, the objects are examined with the user set information at input step 602 which has been stored at step 632 as to, for example, the zone location, minimum object size, optimal direction and the like. At decision step 634, if the objects match the user set information, then an alarm is issued at step 636. If the objects do not match, then the process 600 returns to step 620.

The examination of step 630 is made with respect to the information input into the system 100 by the user. For example, this information may include: a) location information (e.g. a series of points, a polygon etc.); b) minimum size information (e.g. a number of pixels: c) optional direction information (e.g. the direction as viewed on the display 108, remote display/touch screen 118, etc.). In a particular implementation of a system 100 in accordance with the present invention, location information may be stored in the form of linked lists or an array of positions (e.g. <100,200>, <200,330>, <400,400>, <0,250>, <100,200> etc.) wherein each position comprises x and y coordinates on the display 108 or remote display/touch screen 118 or the like.

While there have been described above the principles of the present invention in conjunction with specific systems and methods, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

As used herein, the terms “comprises”, “comprising”, or any other variation thereof, are intended to cover a non-exclusive inclusion, such that a process, method, article, or apparatus that comprises a recitation of certain elements does not necessarily include only those elements but may include other elements not expressly recited or inherent to such process, method, article or apparatus. None of the description in the present application should be read as implying that any particular element, step, or function is an essential element which must be included in the claim scope and THE SCOPE OF THE PATENTED SUBJECT MATTER IS DEFINED ONLY BY THE CLAIMS AS ALLOWED. Moreover, none of the appended claims are intended to invoke paragraph six of 35 U.S.C. Sect. 112 unless the exact phrase “means for” is employed and is followed by a participle.

What is claimed is:

1. A system for moving object detection comprising:
an image sensor for imaging a field;
a user interface for defining at least one detection zone within said field;
a processor coupled to said user interface and said image sensor for detecting if a moving object has entered said at least one detection zone; and
a system responsive to said processor for providing one of an alarm signal to said user or a gate actuation operation in response to detection of a moving object within said at least one detection zone.

2. The system of claim 1 capable of being mounted on a tripod for fixed traffic monitoring applications.

3. The system of claim 2 wherein said alarm signal comprises an auditory and/or visual signal.

4. The system of claim 1 capable of being mounted on a vehicle for mobile traffic monitoring applications.

5. The system of claim 4 wherein said user interface comprises a display incorporating a touch screen interface.

6. The system of claim 1 wherein at least one detection zone comprises a plurality of detection zones.

7. The system of claim 6 wherein at least one attribute may be selected by a user corresponding to each detection zone.

8. The system of claim 7 wherein said at least one attribute comprises an alarm type.

9. The system of claim 1 wherein said at least one detection zone comprises a user selectable polygon.

10. The system of claim 1 further comprising a high speed communication module coupled to said processor for communication with an external device.

11. The system of claim 1 further comprising an impact sensor coupled to said processor.

12. The system of claim 1 further comprising an interface for writing to a removable external storage device.

13. The system of claim 1 further comprising a memory coupled to said processor.

14. The system of claim 1 further comprising a plurality of general purpose input/output ports.

15. A method for moving object detection:
imaging a visual field;
defining at least one user defined detection zone within said visual field;
detecting if a moving object has entered said at least one detection zone; and
creating one of an alarm signal to said user or a gate actuation operation in response to detection of said moving object within said at least one detection zone.

16. The method of claim 15 further comprising continuously monitoring a relative size and direction of objects in said at least one detection zone.

17. The method of claim 16 further comprising setting an alarm level based on said relative size or direction of said objects.

18. The method of claim 15 further comprising continuously monitoring said at least one detection zone to determine which objects are stationary.

19. The method of claim 15 further comprising setting an object size threshold.

20. The method of claim 15 further comprising defining a plurality of detection zones.
